(19) United States
(12) Patent Application Publication
(10) Pub. No.: US 2016/0124941 A1
(43) Pub. Date: May 5, 2016

(54) TRANSLATION DEVICE, TRANSLATION METHOD, AND NON-TRANSITORY COMPUTER READABLE RECORDING MEDIUM HAVING THEREIN TRANSLATION PROGRAM

(71) Applicant: FUJITSU LIMITED, Kawasaki-shi (JP)

(72) Inventor: Yuchang CHENG, Kawasaki (JP)

(73) Assignee: FUJITSU LIMITED, Kawasaki-shi (JP)

(21) Appl. No.: 14/881,851

(22) Filed: Oct. 13, 2015

(30) Foreign Application Priority Data
Nov. 4, 2014 (JP) 2014-224477

(51) Int. Cl. G06F 17/28

(52) U.S. Cl. CPC G06F 17/289; G06F 17/2863; G06F 17/2836

(57) ABSTRACT

A translation device includes a saving unit that, when a first original text in a first language is translated into a second translated text in a second language by a first translation unit, saves a first substring included in the first original text and a second substring included in the second translated text and corresponding to the first substring in association with each other; a second translation unit that translates a second original text in the second language into a first translated text in the first language; and a control unit that, when an inquiry original text is input to the second translation unit, the inquiry original text citing the second substring and inquiring about the second substring, controls the second translation unit so as to substitute the first substring for the second substring included in the inquiry original text based on information saved in the saving unit.

### CROSS-REFERENCE TO RELATED APPLICATION

This application is based upon and claims the benefit of priority of the prior Japanese Patent Application No. 2014-224477, filed on Nov. 4, 2014, the entire contents of which are incorporated herein by reference.

### FIELD

The embodiments discussed herein are related to a translation device, a translation method, and a non-transitory computer readable recording medium having therein program for translation.

### BACKGROUND

To date, when users who use different languages have conversed with each other, the conversation has sometimes been carried out via a translation device that performs translation called automatic translation or machine translation.

When conversation is carried out via such a translation device, the translation device is sometimes not able to appropriately translate an utterance (message) of a user because of mistranslation or the like. Since such an inappropriate translation result includes an ambiguous portion, a user having received the translation result sometimes asks again a user who is the conversation partner for clarification.

Therefore, with regard to a translation result, there are known techniques for inquiring about the content that is not clear.

Examples of the related-art techniques include Japanese Laid-open Patent Publication No. 2003-29779, Japanese Laid-open Patent Publication No. 2008-243076, and Japanese Patent No. 5323499.

### SUMMARY

According to an aspect of the invention, a translation device includes: a saving unit that, when a first original text in a first language is translated into a second translated text in a second language by a first translation unit, saves a first substring included in the first original text and a second substring included in the second translated text and corresponding to the first substring in association with each other; a second translation unit that translates a second original text in the second language into a first translated text in the first language; and a control unit that, when an inquiry original text as the second original text is input to the second translation unit, the inquiry original text citing the second substring included in the second translated text output from the first translation unit and inquiring about the second substring, controls the second translation unit so as to substitute the first substring corresponding to the second substring for the second substring included in the inquiry original text based on information saved in the saving unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a schematic configuration of an example of a translation system according to a first embodiment;

FIG. 2 is a functional block diagram illustrating a schematic configuration of an example of the translation system according to the first embodiment;

FIG. 3 is an explanatory diagram depicting a specific example of an inquiry sentence pattern list;

FIG. 4 is an explanatory diagram representing a specific example of a conceptual structure of a sentence including an inquiry intention;

FIG. 5 is an explanatory diagram for explaining an example of creation of a substring correspondence table by a substring correspondence table creation unit according to the first embodiment;

FIG. 6 is an explanatory diagram depicting a specific example of the substring correspondence table;

FIG. 7 is a block diagram illustrating a schematic configuration of an example of a computer functioning as a terminal device according to the first embodiment;

FIG. 8 is a block diagram illustrating a schematic configuration of an example of a computer functioning as a translation device according to the first embodiment;

FIG. 9 is a flowchart illustrating an example of a translation process executed by the translation device according to the first embodiment;

FIG. 10 is an explanatory diagram for explaining an example of the translation process executed by the translation device according to the first embodiment;

FIG. 11 is a functional block diagram illustrating a schematic configuration of an example of a translation device according to a second embodiment;

FIG. 12 is a block diagram illustrating a schematic configuration of an example of a computer functioning as a terminal device according to the second embodiment;

FIG. 13 is a flowchart illustrating an example of a translation process executed by the translation device according to the second embodiment;

FIG. 14 is an explanatory diagram for explaining an example of the translation process executed by the translation device according to the second embodiment;

FIG. 15 is a diagram illustrating a schematic configuration of another example of the translation system;

FIG. 16 is a diagram illustrating a schematic configuration of another example of the translation system; and

FIG. 17 is a flowchart of an example of an inquiry history delete process in the translation device according to the second embodiment.

### DESCRIPTION OF EMBODIMENTS

When an inquiry is carried out, a message describing the inquiry is sometimes not appropriately translated. In such cases, a user who has received the inquiry is sometimes not able to understand what the inquiry is about. When the message is not appropriately translated, the result of retranslation differs from the original text. As a result, the user who has received the inquiry is sometimes not able to identify a portion for which the inquiry is carried out.

Accordingly, it is desired to carry out an inquiry about an ambiguous portion of a translation result so as to obtain an understandable translation result, when translation is performed between different languages.

### First Embodiment

Hereinafter, an example of the technique of the present disclosure will be described in detail with reference to the accompanying drawings. In the present embodiment, by way of example, the case where one of a first language and a second language of the technique of the present disclosure is Japanese and the other is English will be described. In the present embodiment, the case where a user A using Japanese and a user B using English converse using messages via a translation device will also be described.

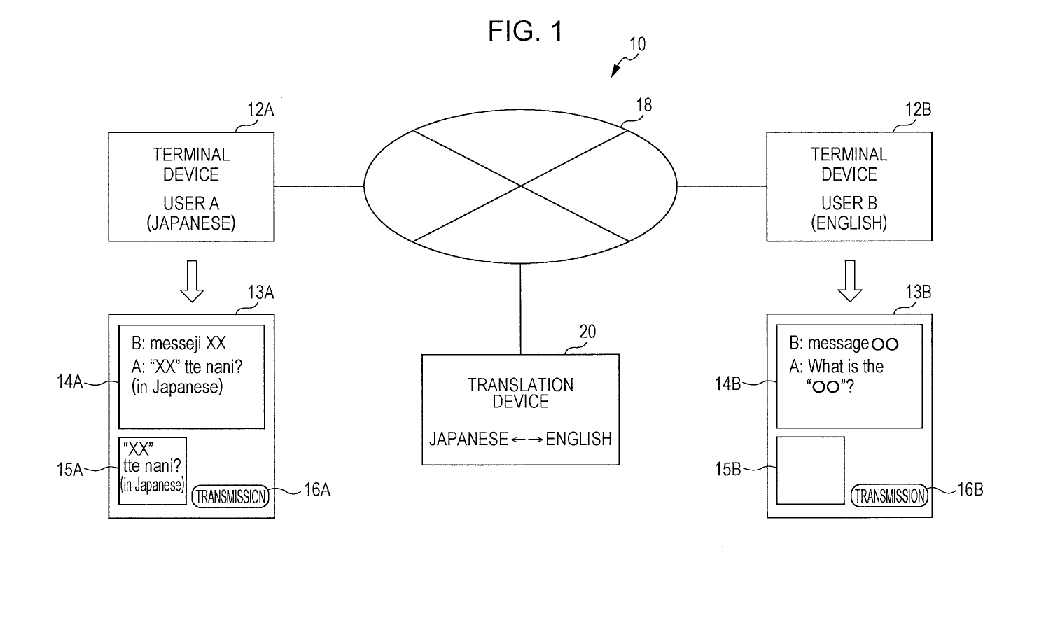

FIG. 1 is a schematic configuration diagram of an example of a translation system 10 according to the present embodiment. As illustrated in FIG. 1, the translation system 10 includes a terminal device 12A used by the user A, a terminal device 12B used by the user B, and a translation device 20. Each of the terminal devices 12A and 12B and the translation device 20 are coupled via a network 18.

The terminal device 12A has a function for allowing the user A to converse with the user B. The terminal device 12B has a function for allowing the user B to converse with the user A. The terminal devices 12A and 12B, being similar devices, are each referred to as a terminal device 12 followed by a mark A or B, which indicates an individual terminal device, when they are individually referred to, and are each referred to as a terminal device 12 when they are collectively referred to without being discriminated from each other. Functional units included in the terminal devices 12A and 12B and users of the terminal devices 12A and 12B are also referred to with the mark A or B indicating an individual unit or user when they are individually referred to, and the mark indicating an individual unit or user is omitted when they are collectively referred to without being discriminated from each other.

The terminal device 12 includes a display unit 13 including a message display unit 14, an input message display unit 15, a transmission button 16, and so on. In the terminal device 12 in the present embodiment, dialogs (messages) of both the users are displayed in a time sequence on the message display unit 14. In the present embodiment, a dialog, which is a character string uttered by a user, is referred to as a message.

Additionally, in the terminal device 12, a message to be uttered input by a user is displayed on the input message display unit 15. Additionally, in the terminal device 12, when the user operates the transmission button 16, the input message displayed on the input message display unit 15 is transmitted to the outside, so that an utterance is performed.

The translation device 20 has a function in which a message received from the terminal device 12, when the language of the message is Japanese, is translated into English and the translated message is transmitted to the terminal device 12B serving as the destination. The translation device 20 also has a function in which a message received from the terminal device 12, when the language of the message is English, is translated into Japanese and the translated message is transmitted to the terminal 12A serving as the destination. In the present embodiment, the translation device 20, by way of specific example, translates a Japanese message received from the terminal device 12A into English and transmits the translated message to the terminal device 12B. The translation device 20 also translates an English message received from the terminal device 12B into Japanese and transmits the translated message to the terminal device 12A.

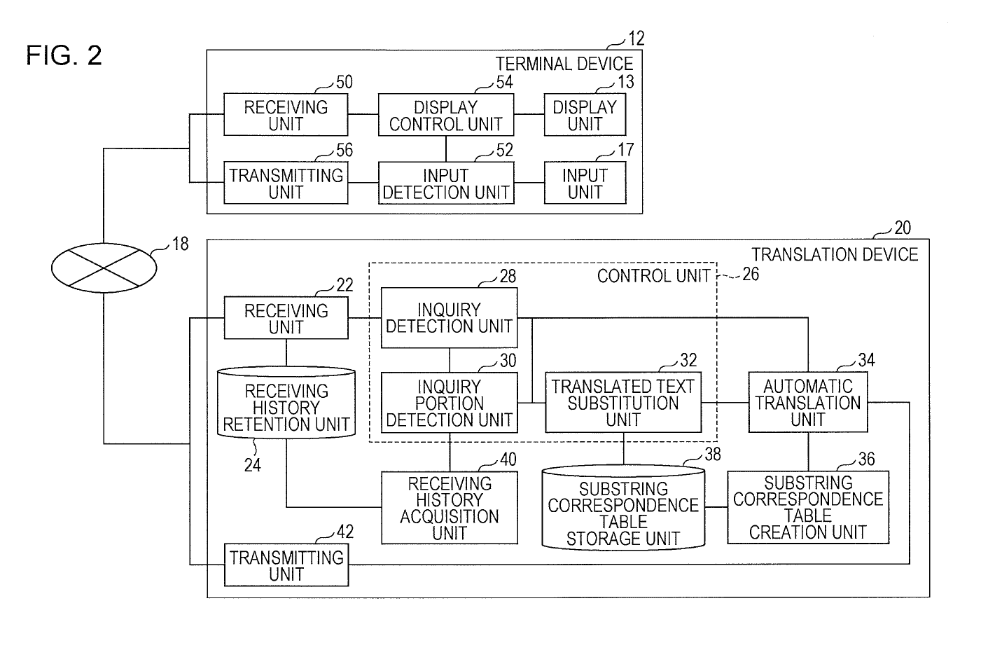

FIG. 2 is a functional block diagram illustrating a functional schematic configuration of an example of the terminal device 12 and the translation device 20.

As illustrated in FIG. 2, the terminal device 12 in the present embodiment includes the display unit 13, an input unit 17, a receiving unit 60, an input detection unit 52, a display control unit 54, and a transmitting unit 56.

The receiving unit 50 has a function of receiving a message translated by the translation device 20.

The display unit 13 has a function of performing display regarding a message transmitted and received (a conversation is held). The display unit 13 in the present embodiment includes the message display unit 14, the input message display unit 15, the transmission button 16, and so on as mentioned above.

The input unit 17 has a function in order for a user to input an instruction or the like regarding a conversation, such as a message to be uttered. Specific examples of the input unit 17 include a keyboard, a mouse, a touch panel, and so on. Note that the display unit 13 and the input unit 17 may be a touch panel into which they are integrated.

The input detection unit 52 has a function of detecting content input by the input unit 17. The display control unit 54 has a function of controlling display of messages or the like on the display unit 13.

The transmitting unit 56 has a function of transmitting messages or the like to the outside.

In contrast, the translation device 20 in the present embodiment includes a receiving unit 22, a receiving history retention unit 24, a control unit 26, an automatic translation unit 34, a substring correspondence table creation unit 36, a substring correspondence table storage unit 38, a receiving history acquisition unit 40, and a transmitting unit 42. The substring correspondence table storage unit 38 is an example of a saving unit of the technique of the present disclosure.

The receiving unit 22 has a function of receiving messages from the terminal device 12.

The receiving history retention unit 24 has a function of retaining messages received by the receiving unit 22 as receiving histories in a time sequence. That is, the receiving history retention unit 24 retains received messages in the order in which they are received, as a database of receiving histories. The messages included in the receiving histories are those of the user A and the user B.

The control unit 26 is an example of a control unit of the technique of the present disclosure and includes an inquiry detection unit 28, an inquiry portion detection unit 30, and a translated text substitution unit 32.

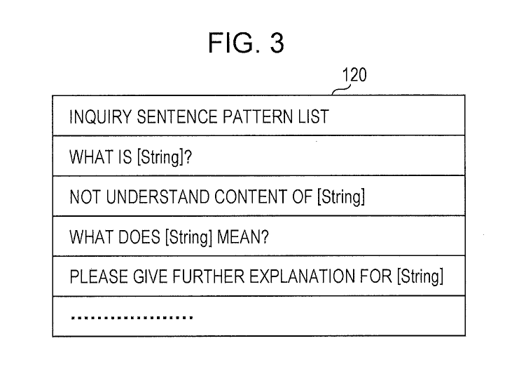

The inquiry detection unit 28 is an example of a first detection unit of the technique of the present disclosure and has a function of detecting whether or not a received message includes an inquiry intention. In the present embodiment, “inquiry” is a response asking the content of an utterance of a conversation partner. The way by which the inquiry detection unit 28 detects whether or not a message includes an inquiry intention is not limited. The inquiry detection unit 28 in the present embodiment, by way of specific example, compares a given inquiry sentence pattern with a message and, when the message matches or is considered to match the given inquiry sentence pattern, detects that the message includes an inquiry intention. FIG. 3 depicts a specific example of an inquiry sentence pattern list. An inquiry sentence pattern list 120 depicts, as a specific example, four inquiry sentence patterns. Note that [String] in the inquiry sentence patterns represents an arbitrary string. In the case where detection is carried out using the inquiry sentence pattern list 120, as in the inquiry detection unit 28 in the present embodiment, the inquiry sentence pattern list 120 is automatically or manually created and is stored in a storage unit (not illustrated in the drawings) such as inside the translation device 20 in advance.

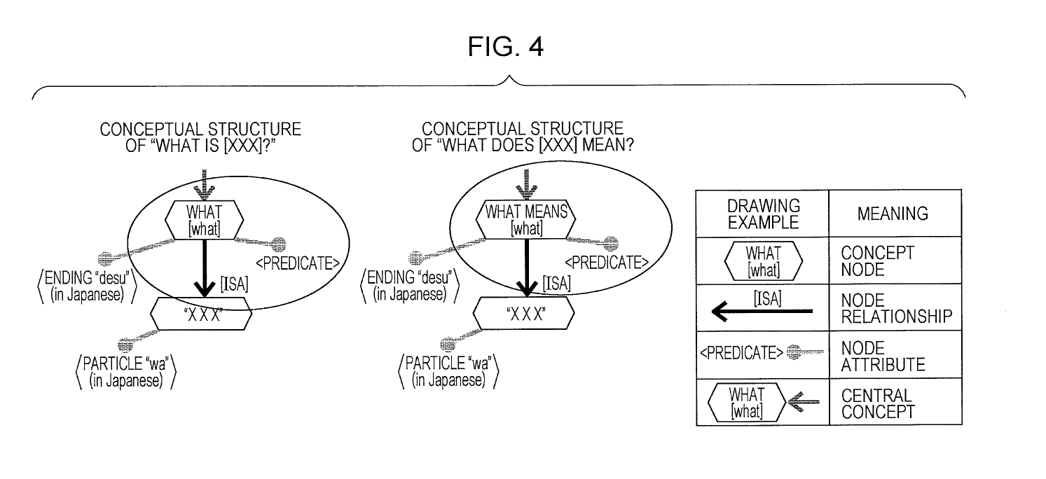

As another example of the way of detection carried out by the inquiry detection unit 28, a way of utilizing a conceptual structure analysis result is mentioned. FIG. 4 illustrates an explanatory diagram representing a specific example of a conceptual structure of a sentence including an inquiry intention. The term “conceptual structure” includes as elements concept symbols of words included in a message (string), and the elements are associated with one another using the relationship based on the semantic attributes of words and the grammatical arrangement of words in the string. A specific example illustrated in FIG. 4 illustrates the conceptual structures of a message “What is [XXX (an arbitrary string)]?” including an inquiry intention and a message “What does [XXX (an arbitrary string)] mean?”. The inquiry detection unit 28 detects that a message includes the inquiry intention when the conceptual structure of the message matches the conceptual structure of a text including the inquiry intention.

The inquiry portion detection unit 30 is an example of a second detection unit of the technique of the present disclosure and has a function of detecting the presence or absence of an inquiry portion in a received message when the message includes an inquiry intention. The way by which the inquiry portion detection unit 30 detects the presence or absence of an inquiry portion in a message is not limited. The inquiry portion detection unit 30 in the present embodiment, by way of specific example, refers to messages of translation results in the past and receiving histories and, when part of a message is included in a translation result or a receiving history, detects the presence of an inquiry portion.

For this reason, the receiving history acquisition unit 40 has a function of acquiring a receiving history (message) from the receiving history retention unit 24 and outputting the receiving history (message) to the inquiry portion detection unit 30.

When an inquiry portion is present in a message, the translated text substitution unit 32 has a function of searching for a translated text component corresponding to the inquiry portion in question in a substring correspondence table stored in the substring correspondence table storage unit 38. When a translated text component corresponding to the inquiry portion in question is present in the substring correspondence table, the translated text substitution unit 32 also has a function of substituting, with reference to the substring correspondence table, an original text component for the strings of the inquiry portion in question. The translated text substitution unit 32 in the present embodiment further has a function of embedding a control code for inhibiting the automatic translation unit 34 from performing translation in the portion of the substituted original text component.

The substring correspondence table is created by the substring correspondence table creation unit 36 and is stored in the substring correspondence table storage unit 38. For this reason, the substring correspondence table creation unit 36 in the present embodiment has a function of creating a substring correspondence table based on a translation result of the automatic translation unit 34 and the original text and causing the created substring correspondence table to be stored in the substring correspondence table storage unit 38.

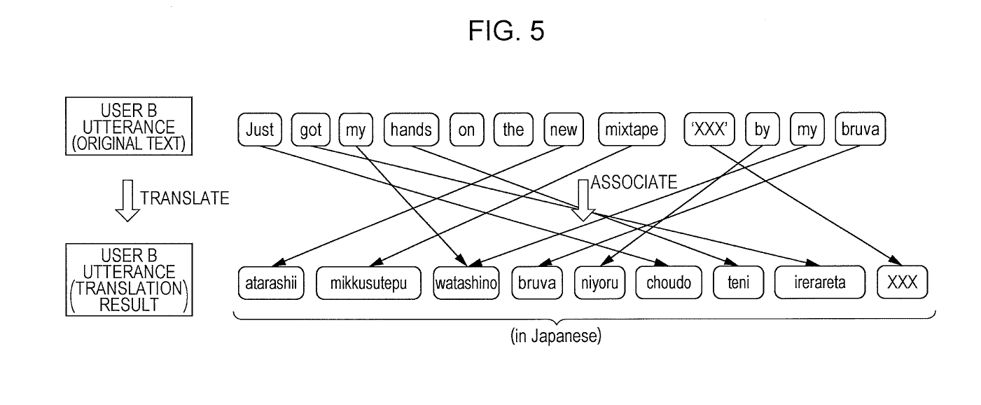

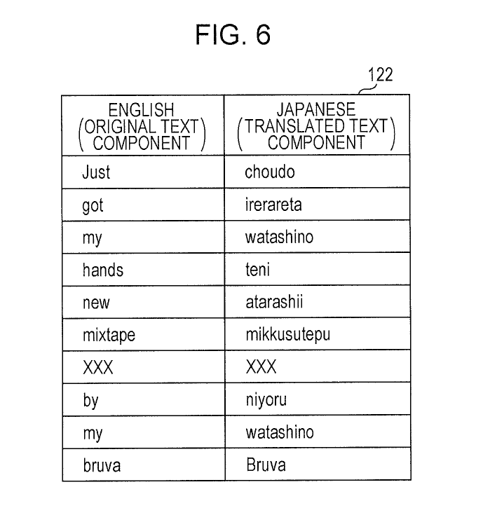

The substring correspondence table in the present embodiment and the creation thereof will be described with reference to FIG. 5 and FIG. 6. FIG. 5 is an explanatory diagram for explaining an example of creation of a substring correspondence table by the substring correspondence table creation unit 36. FIG. 6 is an explanatory diagram depicting a specific example of the substring correspondence table 122.

In the specific example depicted in FIG. 5 and FIG. 6, the case where the receiving unit 22 receives a message (original text) “Just got my hands on the new mixtape ‘XXX’ by my bruva.” from the terminal device 12B and the automatic translation unit 34 translates the message into Japanese is illustrated. The substring correspondence table creation unit 36 decomposes the original text and the translation result into words and associates the words with each other. In the present embodiment, words into which an original text is decomposed are parts of the original text and thus are referred to as original text components. Words into which a translation result is decomposed are parts of the translation result and thus are referred to as translated text components.

The substring correspondence table creation unit 36, upon associating the words with each other, causes the substring correspondence table 122 representing the bilingual relationship of the original text components and the translated text components to be stored in the substring correspondence table storage unit 38.

Note that, in some cases, there is an original text component that is not reflected (not directly translated) in a translation result. For example, in the specific example depicted in FIG. 5, “on” and “the” correspond to original text components that are not reflected in a translation result. Since such an original text component is not reflected in a translation result, the original text component is not associated with a translated text component and is not stored in the substring correspondence table 122.

The automatic translation unit 34 is an example of a first translation unit and a second translation unit of the technique of the present disclosure and has a function of translating a message received by the receiving unit 22 into Japanese or English. The translation way is not limited, and a typical way called automatic translation or machine translation may be used. Note that, when a message is embedded with a control code by the translated text substitution unit 32, the automatic translation unit 34 in the present embodiment has a function of not translating a portion with the control code and translating the other portions. By not translating the portion with the control code in such a way, an inquiry portion in a message is substituted by original text components. Note that the control code for inhibiting the automatic translation unit 34 from translating is not limited, and an arbitrary control code in accordance with a translation system of the automatic translation unit 34 may be used.

The transmitting unit 42 has a function of transmitting a message translated by the automatic translation unit 34 to the destination.

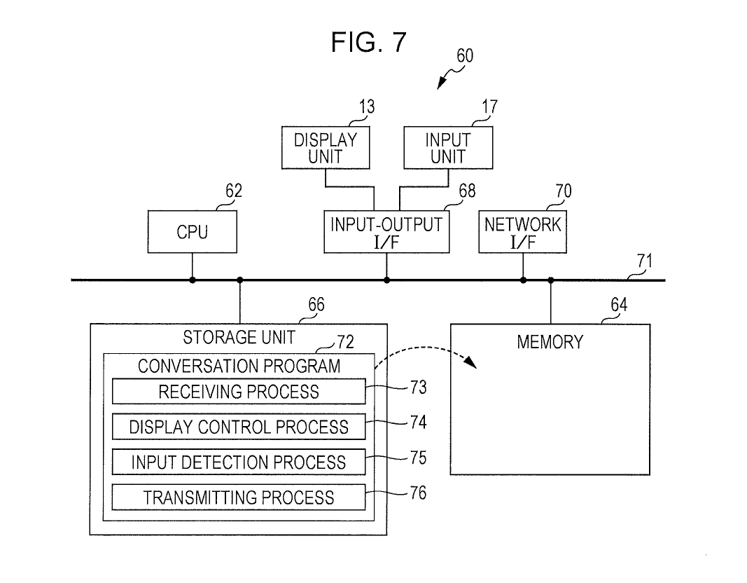

Note that the terminal device 12 may be implemented, for example, by a computer 60 illustrated in FIG. 7. The computer 60 includes a central processing unit (CPU) 62, a memory 64, a nonvolatile storage unit 66, an input-output interface (I/F) 68, and a network I/F 70. The CPU 62, the memory 64, the storage unit 66, the input-output I/F 68, and the network I/F 70 are mutually coupled via a bus 71. The input-output I/F 68 is coupled to the display unit 13 and the input unit 17.

The storage unit 66 may be implemented by a hard disk drive (HDD), a flash memory, or the like. In the storage unit 66 serving as a storage medium, a conversation program 72 for causing the computer 60 to function as the terminal device 12 is stored. The CPU 62 reads the conversation program 72 from the storage unit 66 and loads it into the memory 64 and then sequentially executes processes that the conversation program 72 has.

The conversation program 72 includes a receiving process 73, a display control process 74, an input detection process 75, and a transmitting process 76. The CPU 62 executes the receiving process 73 and thus operates as the receiving unit 50. The CPU 62 also executes the display control process 74 and thus operates as the display control unit 54. The CPU 62 also executes the input detection process 75 and thus operates as the input detection unit 52. The CPU 62 further executes the transmission process 76 and thus operates as the transmitting unit 56.

Thus, the computer 60 executing the conversation program 72 functions as the terminal device 12.

Note that the computer 60 is not limited to a so-called desktop personal computer. The computer 60 may be a laptop personal computer, personal digital assistants (PDA) typified by a tablet terminal and a smartphone, or the like.

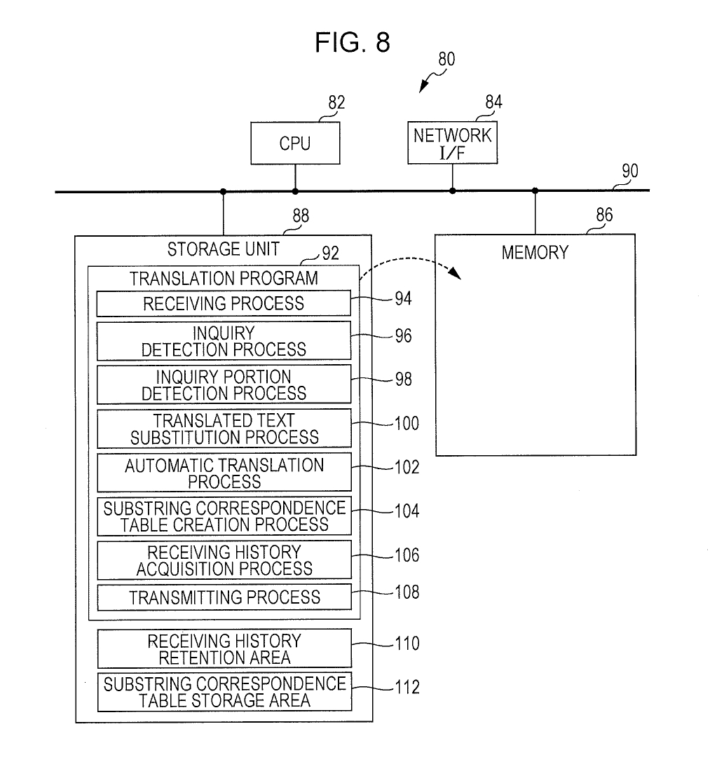

The translation device 20 may also be implemented, for example, by a computer 80 illustrated in FIG. 8. The computer 80 includes a CPU 82, a network I/F 84, a memory 86, and a nonvolatile storage unit 88. The CPU 82, the network I/F 84, the memory 86, and the nonvolatile storage unit 88 are mutually coupled via a bus 90.

The storage unit 88 may be implemented by an HDD, a flash memory, or the like. In the storage unit 88 serving as a storage medium, a translation program 92 for causing the computer 80 to function as the translation device 20 is stored. The CPU 82 reads the translation program 92 from the storage unit 88 and loads it into the memory 86 and then sequentially executes processes that the translation program 92 has.

The translation program 92 includes a receiving process 94, an inquiry detection process 96, an inquiry portion detection process 98, a translated text substitution process 100, and an automatic translation process 102. The translation program 92 also includes a substring correspondence table creation process 104, a receiving history acquisition process 106, and a transmitting process 108.

A receiving history retention area 110 in the storage unit 88 functions as a storage area in which receiving histories are retained. A substring correspondence table storage area 112 in the storage unit 88 functions as a storage area in which a substring correspondence table is stored.

The CPU 82 executes the receiving process 94 and thus operates as the receiving unit 22. The CPU 82 also executes the inquiry detection process 96 and thus operates as the inquiry detection unit 28. The CPU 82 also executes the inquiry portion detection process 98 and thus operates as the inquiry portion detection unit 30. The CPU 82 also executes the translated text substitution process 100 and thus operates as the translated text substitution unit 32. The CPU 82 also executes the automatic translation process 102 and thus operates as the automatic translation unit 34. The CPU 82 also executes the substring correspondence table creation process 104 and thus operates as the substring correspondence table creation unit 36. The CPU 82 also executes the receiving history acquisition process 106 and thus operates as the receiving history acquisition unit 40. The CPU 82 further executes the transmitting process 108 and thus operates as the transmitting unit 42.

Thus, the computer 80 executing the translation program 92 functions as the translation device 20. Note that the translation program 92 is an example of a translation program according to the technique of the present disclosure.

Note that the terminal device 12 and the translation device 20 may be implemented, for example, by a semiconductor integrated circuit, more particularly, an application specific integrated circuit (ASIC), or the like.

Next, the operations of the translation device 20 of the translation system 10 according to the present embodiment will be described.

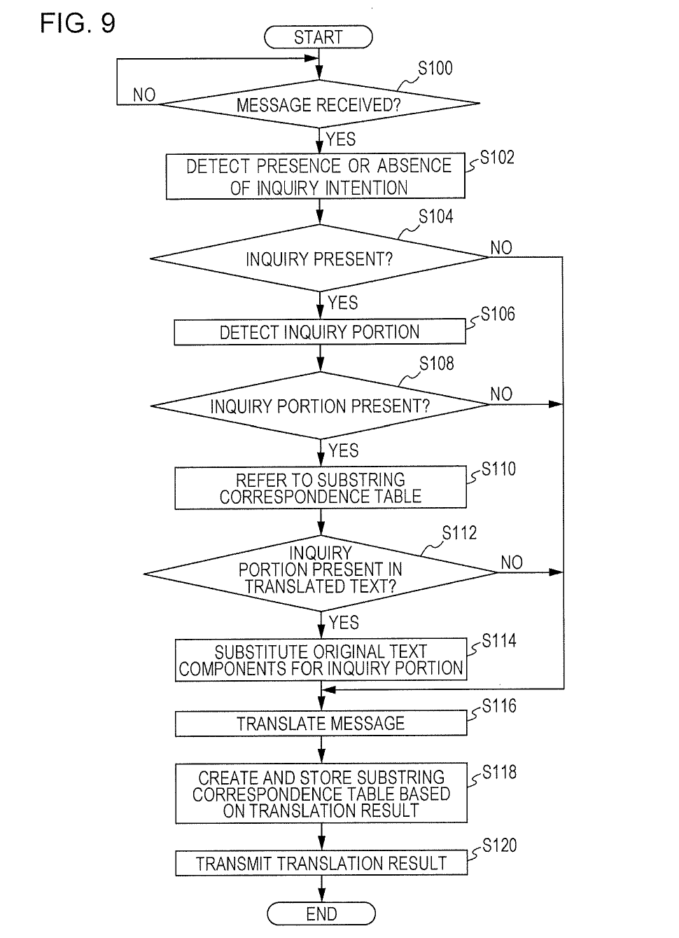

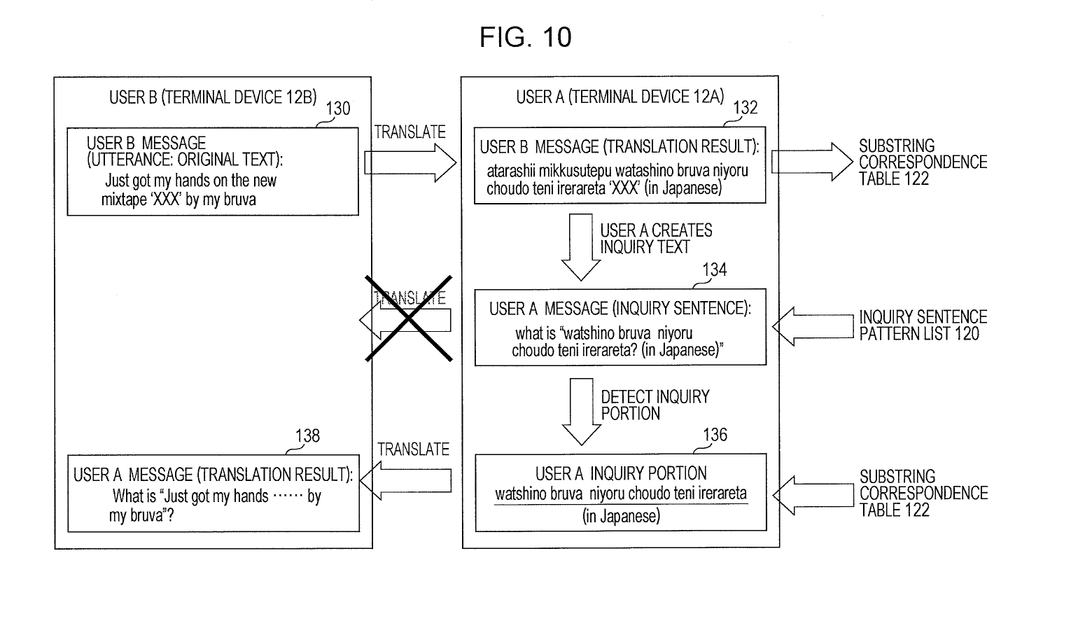

A translation process performed in the translation device 20 will be described. FIG. 9 is a flowchart illustrating an example of the translation process performed in the translation device 20 in the present embodiment. The translation process illustrated in FIG. 9 is performed each time the translation device 20 receives a message from the terminal device 12. FIG. 10 illustrates an explanatory diagram for explaining a specific example of a translation process executed by the translation device 20 according to the present embodiment. Detailed description will be given below with reference to the specific example illustrated in FIG. 10.

First, description is given of the procedure of the translation process executed when, prior to an utterance of the user A, a message 130 saying “Just got my hands on the new mixtape ‘XXX’ by my bruva.”, which is an utterance of the user B, is received as in the specific example illustrated in FIG. 10.

In step S100, the receiving unit 22 of the translation device 20 determines whether or not a message is received. When no message is received, the translation device 20 enters a waiting state. On the other hand, when a message is received, the process proceeds to step S102. Received messages are time sequentially retained as receiving histories in the receiving history retention unit 24. Consequently, the message 130 is retained in the receiving history retention unit 24.

In step S102, the inquiry detection unit 28 of the translation device 20 detects whether or not the received message includes the inquiry intention. When, as a result of comparison with inquiry sentence patterns, the inquiry detection unit 28 detects that the message 130 does not include the inquiry intention, the process proceeds to step S116.

In step S116, the automatic translation unit 34 translates the message 130. The message 130 is translated into a message 132 “Atarashii mikkusutepu watashino bruva niyoru choudo teni irerareta ‘XXX’” (in Japanese) as in the specific example illustrated in FIG. 10.

In the next step S118, the substring correspondence table creation unit 36 creates the substring correspondence table 122 based on the message 132 as a translation result and causes the substring correspondence table 122 to be stored in the substring correspondence table storage unit 38.

In the next step S120, the transmitting unit 42 transmits the message 132 as the translation result to the destination (the terminal device 12A of the user A) and then this process is completed.

The message 132 as the translation result is received by the receiving unit 50 of the terminal device 12A. The received message 132 is displayed as an utterance (message) of the user B on the display unit 13A of the terminal device 12A.

When the message 132 includes a portion with the content that is not understandable, the user A creates a message 134 serving as an inquiry text for inquiring about the portion that is not understandable and inputs the message 134 with the input unit 17. At this point, the user A uses, as an inquiry portion, the portion with the content that is not understandable included in the message 132 as it is, creates the message 134 serving as an inquiry text, and transmits the message 134 with the transmitting unit 56. In the specific example illustrated in FIG. 10, a message 134 saying “What is “watashino bruva niyoru choudo teni irerareta” (in Japanese)?” is transmitted from the terminal device 12A.

The message 134, which is an inquiry text, is received by the receiving unit 22 of the translation device 20.

Next, the procedure of the translation process executed when the message 134, which is an inquiry text, is received will be described.

Once the receiving unit 22 of the translation device 20 receives the message 134, the process proceeds from step S100 to step S102. The received message 134 is time sequentially retained as a receiving history in the receiving history retention unit 24. Consequently, the message 134 is retained as a receiving history next to the message 130.

In step S102, the inquiry detection unit 28 of the translation device 20 detects whether or not the received message 134 includes the inquiry intention. In the present embodiment, as the specific example as described above, the inquiry detection unit 28 detects whether the inquiry intention is present or absent, based on a result of comparison between the message 134 and inquiry sentence patterns with reference to the inquiry sentence pattern list 120. Since the message 134 matches an inquiry sentence pattern included in the inquiry sentence pattern list 120, the inquiry detection unit 28 detects that the inquiry intention is present, and the process proceeds to step S106.

In step S106, the inquiry portion detection unit 30 detects an inquiry portion in the message 134. When a message does not contain an inquiry portion, different from the message 134, the process proceeds to step S116. That is, in the case where, although a message matches an inquiry sentence pattern of the inquiry sentence patter list 120, an inquiry is carried out without citing a portion in the message 132, for example, in the case where an inquiry is carried out using a message such as “not understand the content of the message”, the process proceeds to step S116.

Once the inquiry portion detection unit 30 detects an inquiry portion in the message 134, the process proceeds to step S110. In the specific example illustrated in FIG. 10, the inquiry portion detection unit 30 detects “watashino bruva niyoru choudo teni irerareta” (in Japanese) as the inquiry portion 136.

In step S110, the translated text substitution unit 32 refers to the substring correspondence table 122 stored in the substring correspondence table storage unit 38. In the next step S112, the translated text substitution unit 32 searches for the presence of the inquiry portion 136 among translated text components in the substring correspondence table 122. When the inquiry portion 136 is absent among the translated text components, the process proceeds to step S116. On the other hand, when the inquiry portion 136 is present among the translated text components, the process proceeds to step S114.

In step S114, the translated text substitution unit 32 substitutes original text components for the inquiry portion 136 of the message 134 based on the substring correspondence table 122. The translated text substitution unit 32 in the present embodiment embeds a control code in the portion of the substituted original text components.

In the next step S116, the automatic translation unit 34 translates the message 134. Since the message 134 is embedded with the control code, the automatic translation unit 34 does not translate the portion with the control code embedded so that the portion is left in a state of the original text components. The automatic translation unit 34 translates the other portion of the message 134. In the specific example illustrated in FIG. 10, a message 138 saying “What is “Just got my hands . . . by my bruva” ?” is a translation result.

In the next step S118, the substring correspondence table creation unit 36 creates the substring correspondence table 122 based on the message 138 as the translation result and causes the substring correspondence table 122 to be stored in the substring correspondence table storage unit 38. Note that a new substring correspondence table may be created or an addition may be provided to the substring correspondence table 122 created from messages obtained before.

In the next step S120, the transmitting unit 42 transmits the message 138 as the translation result to the destination (the terminal device 12B of the user B) and then this process is completed.

In the terminal device 12B having received the message 138, the message 138 is displayed on the display unit 13. The message 138 allows the user B to appropriately and more accurately grasp a portion about which the user A inquires.

As described above, with the translation device 20 in the present embodiment, when a message is translated by the automatic translation unit 34, the substring correspondence table creation unit 36 creates the bilingual relationship between translated text components in a translation result and original text components in an original text. The created substring correspondence table is stored in the substring correspondence table storage unit 38. Further, the inquiry detection unit 28 detects that a message including an inquiry citing, as an inquiry portion, a translation result obtained before by translating a message is received. When the presence of the inquiry intention is detected, the inquiry portion detection unit 30 detects an inquiry portion from the message in question. The translated text substitution unit 32 searches the substring correspondence table storage unit 38, substitutes an original text component for the inquiry portion, and embeds a control code for inhibiting translation. The automatic translation unit 34 causes the portion where the control code is embedded to remain in the original text components and translates the other portions. The transmitting unit 42 transmits a translation result of the automatic translation unit 34 to the terminal device 12 serving as the destination.

In such a way, the automatic translation unit 34 in the present embodiment, when an inquiry is carried out, does not translate the entire message including the inquiry. For example, when, although a translation result includes ambiguous content caused by a mistranslation in a translation result, an inquiry is carried out and the entire message of the inquiry including the mistranslation is translated as it is, a further mistranslation is highly likely to occur. As a result, a user who has received the inquiry is not able to understand what is being inquired about, or is not able to grasp a portion corresponding to the inquiry in the transmitted message. This causes an obstacle to a conversation in some cases.

In contrast, the translation device 20 in the present embodiment, when an inquiry is carried out, does not translate the entire message of the inquiry as it is and substitutes original text components. Consequently, the user having received the inquiry may grasp the content of the inquiry appropriately and the portion corresponding to the inquiry accurately. This may reduce the frequency at which obstacles to conversations due to repetition of inquiries that occurs when one user who has received an inquiry from the other user further inquiries of the other user about the content of the inquiry. Thus, communication between users using the translation device 20 is made smooth.

Accordingly, with the translation device 20 in the present embodiment, when translation is performed between different languages, an appropriate inquiry about an ambiguous portion in a translation result may be carried out.

### Second Embodiment

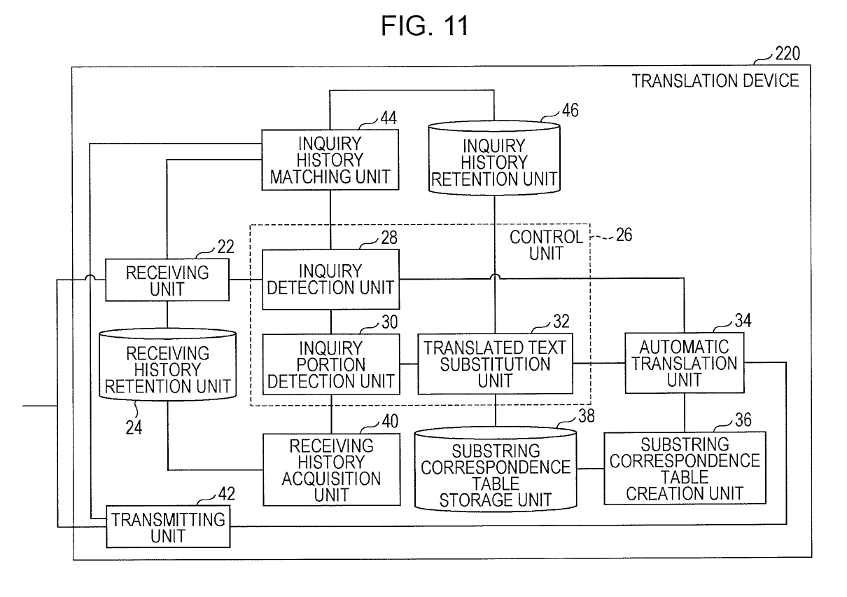

The overall configuration of a translation system in the present embodiment is similar to that in the first embodiment; however, their translation devices are different. A translation device in the present embodiment will be described. FIG. 11 is a functional block diagram illustrating a schematic configuration of an example of the translation device according to the present embodiment. Note that the same components as those in the translation device 20 in the first embodiment are denoted by the same reference numerals and detailed description thereof is omitted.

A translation device 220 in the present embodiment, as illustrated in FIG. 11, further includes an inquiry history matching unit 44, which is an example of a matching unit of the technique of the present disclosure, and an inquiry history retention unit 46, which is an example of a retention unit of the technique of the present disclosure.

In the inquiry history retention unit 46, the bilingual relationship between translation text components substituted by the translated text substitution unit 32 and original text components is retained as an inquiry history. Since the translated text components substituted by the translated text substitution unit 32 constitute an inquiry portion, the history of what translated text components the inquiry has been about is retained as an inquiry history in the history retention unit 46. Note that not the translated text components substituted by the translated text substitution unit 32 but the bilingual relationship between an inquiry portion detected by the inquiry portion detection unit 30 and original text components corresponding to the inquiry portion may be retained as an inquiry history in the inquiry history retention unit 46.

Note that, regarding the inquiry history retained in the inquiry history retention unit 46, the bilingual relationship between a translated text component and an original text component for each word may be used as the inquiry history. Regarding the inquiry history, when an inquiry portion is a sentence including a plurality of words, the bilingual relationship for each sentence may be used as the inquiry history.

The inquiry history matching unit 44 has a function of determining whether the possibility that an inquiry about a message received by the receiving unit 22 will be carried out is present or absent. In the present embodiment, the inquiry history matching unit 44 compares a message received by the receiving unit 22 with original text components of an inquiry history retained in the inquiry history retention unit 46. When original text components that match the message are present, the possibility that an inquiry about this message will be carried out is present. For this reason, the inquiry history matching unit 44 generates information for warning representing the possibility and provides an instruction for transmitting the information with the transmitting unit 42 to the source of transmission of the message in question.

Note that the way by which the inquiry history matching unit 44 determines whether the possibility that an inquiry about a message received will be carried out is present or absent is not limited to the above way. For example, the presence or absence of the possibility of inquiry may be determined by translating a received message by the automatic translation unit 34 and comparing the original text and a translation result of the message with inquiry histories retained in the inquiry history retention unit 46.

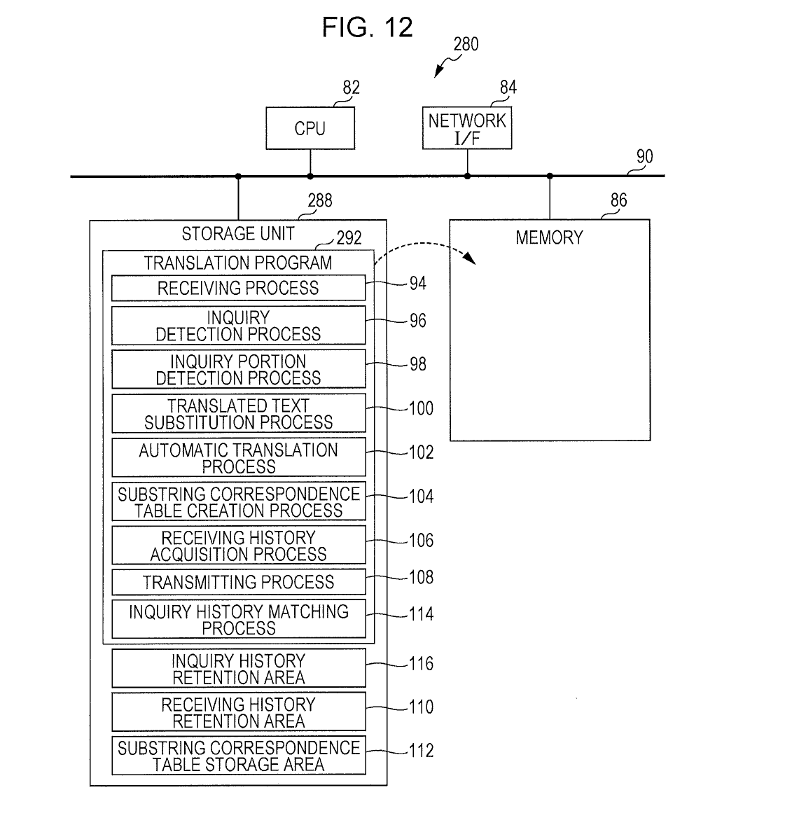

The translation device 220 in the present embodiment may be implemented, for example, by a computer 280 illustrated in FIG. 12. The computer 280 is similar to the computer 80 in the first embodiment, and thus the same components as those in the first embodiment are denoted by the same reference numerals and detailed description thereof is omitted. The computer 280 includes a storage unit 288 in place of the storage unit 88.

In the storage unit 288, a translation program 292 for causing the computer 280 to function as the translation device 220 is stored.

The translation program 292 in the present embodiment includes an inquiry history matching process 114 in addition to processes that the translation program 92 in the first embodiment has. The CPU 82 executes the inquiry history matching process 114 and thus operates as the inquiry history matching unit 44.

The inquiry history retention area 116 of the storage unit 288 functions as a storage area where inquiry histories are retained.

Thus, the computer 280 executing the translation program 292 functions as the translation device 220. The translation program 292 is also an example of the translation program according to the technique of the present disclosure.

Next, the operations of the translation device 220 according to the present embodiment will be described.

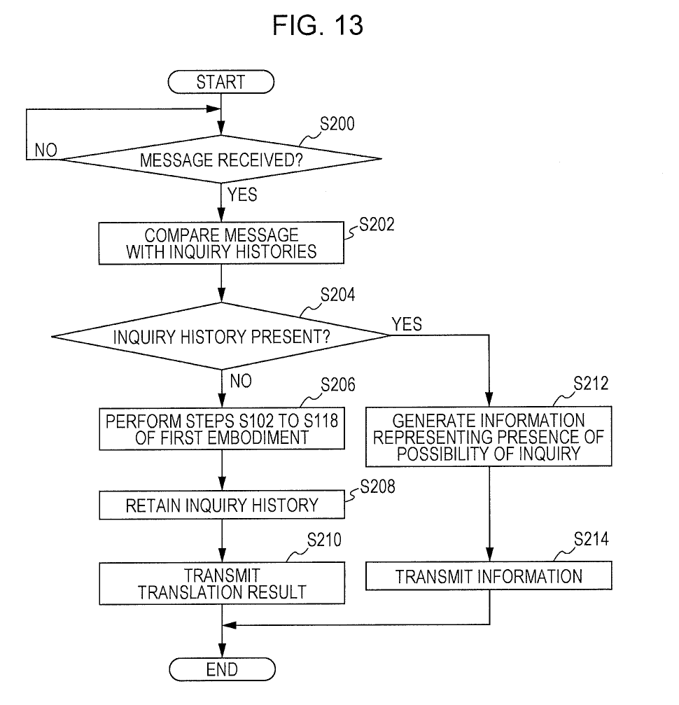

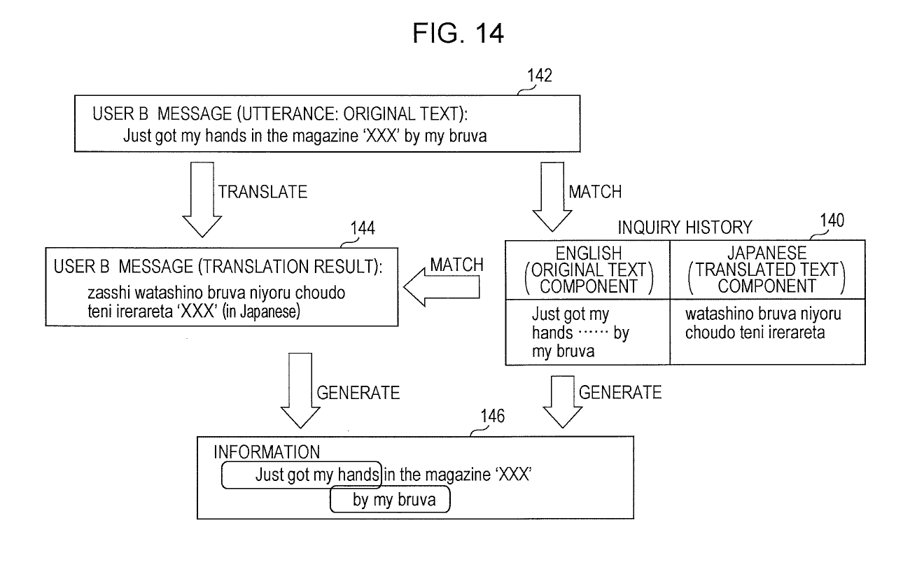

A translation process performed in the translation device 220 will be described. FIG. 13 is a flowchart illustrating an example of a translation process performed in the translation device 220 in the present embodiment. The translation process illustrated in FIG. 13 is performed each time the translation device 220 receives a message from the terminal device 12. FIG. 14 illustrates an explanatory diagram for explaining a specific example of the translation process executed by the translation device 220 according to the present embodiment. Detailed description will be given below with reference to the specific example illustrated in FIG. 14.

First, the case where inquiry histories are retained in the inquiry history retention unit 46 is described specifically. The specific example is described using the case described as the specific example in the first embodiment where, using the message 134 of the user A, an inquiry is carried out for the translation result 132 of the utterance of the message 130 of the user B.

In step S200, as in step S100 of the translation process in the first embodiment (refer to FIG. 9), the receiving unit 22 of the translation device 220 determines whether or not a message is received. When no message is received, the translation device 220 enters a waiting state. On the other hand, when a message is received, the process proceeds to step S202. In the case where the message 132 is received, the message 132 is retained as a receiving history in the receiving history retention unit 24, and the process further proceeds to step S202.

In step S202, the inquiry history matching unit 44 compares the received message 132 with inquiry histories retained in the inquiry history retention unit 46. In the next step S204, the message 132 does not include original text components that match any inquiry history, and thus the process proceeds to step S206.

In step S206, processing in steps S102 to S118 in the first embodiment is performed. When a received message does not include an inquiry intention, for example, the message is translated, as it is, by the automatic translation unit 34, so that a translation result is obtained. On the other hand, when, as in the case of the message 134, the inquiry detection unit 28 detects the presence of an inquiry intention, the inquiry portion detection unit 30 detects an inquiry portion from the message. The translated text substitution unit 32 searches the substring correspondence table storage unit 38, substitutes original text components for the inquiry portion and embeds a control code for inhibiting translation. The automatic translation unit 34 causes the portion where the control code is embedded to remain in the original text components and translates the other portions. The substring correspondence table creation unit 36 creates the substring correspondence table 122 based on the message 138 as a translation result and causes the substring correspondence table 122 to be stored in the substring correspondence table storage unit 38.

In the translation process in the present embodiment, in the next step S208, the inquiry history matching unit 44 retains an inquiry history in the inquiry history retention unit 46. In the specific examples illustrated in FIG. 10 and FIG. 14, the bilingual relationship between original text components “Just got my hands . . . by my bruva” and translated text components “watashino bruva niyoru choudo teni irerareta” (in Japanese) is retained as an inquiry history 140 in the inquiry history retention unit 46.

Then, in step S210, as in step S120 in the first embodiment, the transmitting unit 42 of the translation device 220 transmits a message as a translation result to the destination (the terminal device 12B).

Next, the translation process in the present embodiment performed after an inquiry history is retained in the inquiry history retention unit 46 in this way will be described.

It is assumed that the user B receives, from the terminal device 12B, a message 142 “Just got my hands in the magazine ‘XXX’ by my bruva.” as an utterance of the user B included in the specific example illustrated in FIG. 14.

Once the receiving unit 22 of the translation device 220 receives the message 142, the process proceeds from step S200 to step S202. Note that the received message 142 is also retained as a receiving history in the receiving history retention unit 24.

In step S202, the inquiry history matching unit 44 compares the received message 142 with the inquiry history 140 retained in the inquiry history retention unit 46. In the specific example illustrated in FIG. 14, since the message 142 includes original text components “Just got my hands . . . by my bruva”, in the next step S204, it is determined by the inquiry history matching unit 44 that an inquiry history is present, and the process proceeds to step S212.

In step S212, the inquiry history matching unit 44 generates information representing that, when the message 142 is transmitted to the user A (the terminal device 12A), there is a possibility that an inquiry will be carried out. The information is not limited but it is preferable not only to transmit the presence of a possibility that an inquiry will be carried out but to point out what portion in the message for which the inquiry will be carried out. In the present embodiment, as the specific example, the inquiry history matching unit 44 generates information 146 illustrated in FIG. 14.

In the next step S214, the transmitting unit 42 transmits the information 146 generated by the inquiry history matching unit 44 to the user B (the terminal device 12B) as the source of transmission of the message 142, and then this process is completed.

In the terminal device 12B having received the information 146, the information 146 is displayed on the display unit 13. The user B confirms the information 146. Note that, in consideration with the possibility of inquiry, the user B modifies a portion pointed out (changes the portion to a different expression) and may transmit a new utterance as a message.

The user B may also instruct the translation device 220 to translate the message 142, regardless of the information 146, and to transmit the message 142 to the user A (the translation device 20A). When such an instruction for translating the message 142 is issued, regardless of inquiry histories, the receiving unit 22 of the translation device 220 receives the instruction.

The translation device 220 having received the instruction skips step S202 and step S204 of the translation process and proceeds from step S200 to step S206. That is, the process similar to the translation process in the first embodiment is performed. In the specific example illustrated in FIG. 14, the automatic translation unit 34 translates the message 142. A message 144 “Zasshi watashino bruva niyoru choudo teni irerareta ‘XXX’” (in Japanese) is a translation result. Consequently, the transmitting unit 42 transmits the message 144.

Note that, as described above, when the message 142 is received, the message 142 is translated into the message 144 by the automatic translation unit 34, and the message 144 as the translation result may be compared with the inquiry history 140.

Note that inquiry histories retained in the inquiry history retention unit 46 described in the present embodiment may be used for a conversation among a plurality of users.

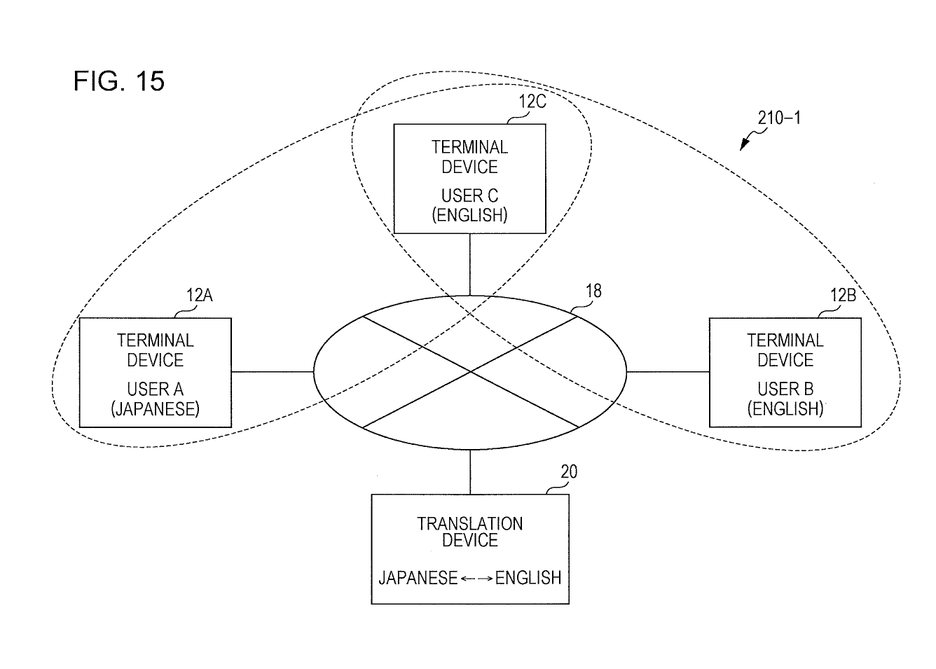

For example, a translation system 210-1 in which a terminal device 12A of the user A, a terminal device 12B of the user B, and a terminal device 12C of the user C are coupled to the network 18, illustrated in FIG. 15, is mentioned as an example. In order to translate a conversation between the user A and the user C, the translation device 20 may utilize an inquiry history retained, in the inquiry history retention unit 46, as a result of translation of a conversation between the user A and the user B performed by the translation device 20. Similarly, in order to translate a conversation between the user A and the user B, the translation device 20 may utilize an inquiry history retained, in the inquiry history retention unit 46, as a result of translation of a conversation between the user A and the user C performed by the translation device 20.

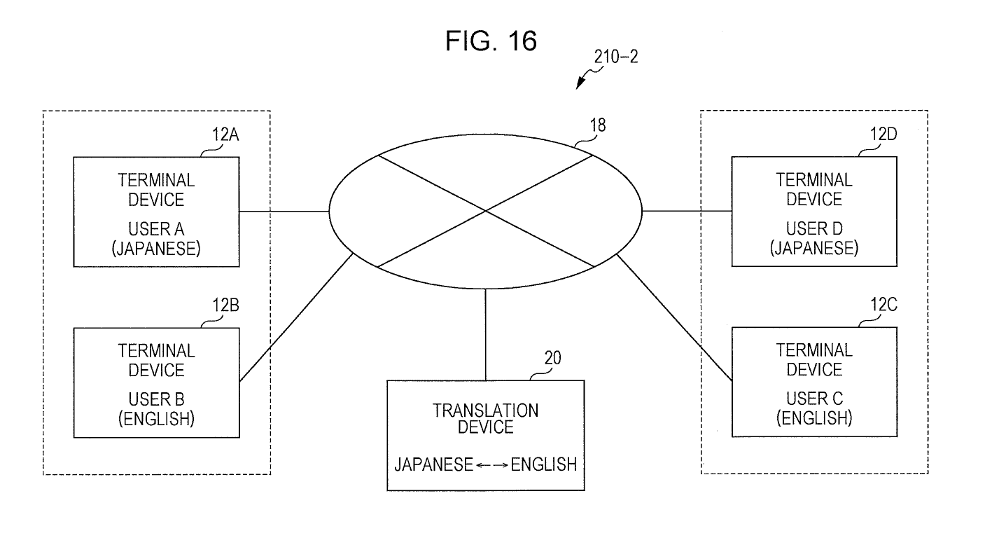

Additionally, for example, a translation system 210-2 in which the terminal device 12A of the user A, the terminal device 12B of the user B, the terminal device 12C of the user C, and a terminal device 12D of a user D are coupled to the network 18, illustrated in FIG. 16, is mentioned as an example. In order to translate a conversation between the user C and the user D, the translation device 20 may utilize an inquiry history retained, in the inquiry history retention unit 46, as a result of translation of a conversation between the user A and the user B performed by the translation device 20. Similarly, in order to translate a conversation between the user A and the user B, the translation device 20 may utilize an inquiry history retained, in the inquiry history retention unit 46, as a result of translation of a conversation between the user C and the user D performed by the translation device 20.

In this way, in the translation device 220 in the present embodiment, the inquiry history matching unit 44 determines whether the possibility of inquiry is present or absent, based on inquiry histories retained in the inquiry history retention unit 46. This reduces the frequency at which inquiries are carried out. Thus, in the translation device 220 in the present embodiment, conversations are made more smoothly and the time and cost for inquiries are reduced.

In the translation device 220 in the present embodiment, as in the translation device 20 in the first embodiment, it is to be understood that, with the translation device 20 in the present embodiment, when translation is performed between different languages, an appropriate inquiry about an ambiguous portion of the translation result may be carried out.

Note that, as described above, in the translation device 220 in the present embodiment, when it is determined that the possibility of inquiry for a received message is present, information representing the possibility is transmitted to the user (the terminal device 12) as the source of transmission of the message for the purpose of warning. However, in some cases, a user determines that warning is unnecessary. For example, in the above-mentioned translation system 210-2, based on inquiry histories based on conversations between the user A and the user B, the translation device 20 sometimes warns the user C or D. The user C or D having received the warning sometimes determines that warning is unnecessary. In particular, there are some cases where an increasing number of users using the translation device 20 or an increasing number of conversations causes a large amount of inquiry histories to be retained or warning to occur frequently. In such cases, a user sometimes determines that warning is unnecessary.

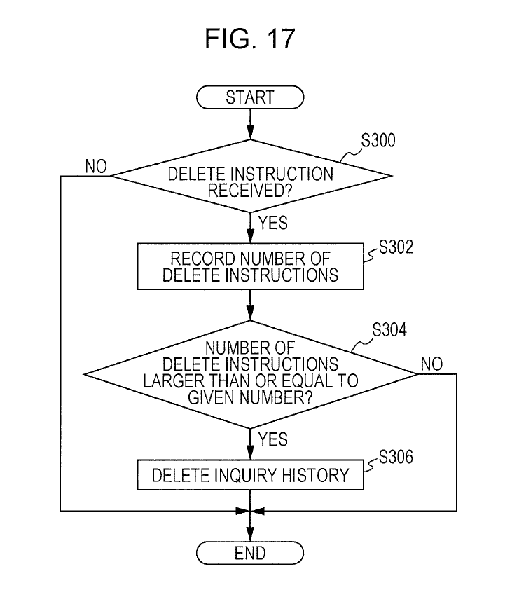

In such a case, it is preferable that, in accordance with an instruction of the user, the translation device 220 delete an inquiry history. The operation of the translation device 220 in this case will be described. FIG. 17 illustrates a flowchart of an example of an inquiry history delete process in the translation device 220. First, a user warned of the possibility of inquiry, when the warning is unnecessary, issues a delete instruction by using the input unit 17 of the terminal device 12.

In step S300, the receiving unit 22 of the translation device 220 determines whether or not the delete instruction is received. When the delete instruction is not received, the translation device 220 enters a waiting state. On the other hand, when the delete instruction is received, the process proceeds to step S302.

In step S302, the inquiry history matching unit 44 records the number of delete instructions in association with an inquiry history corresponding to the received delete instruction retained in the inquiry history retention unit 46.

In the next step S304, the inquiry history matching unit 44 determines whether or not the number of delete instructions associated with inquiry histories is larger than or equal to a predetermined number. The translation device 220, when receiving a delete instruction, may immediately delete an inquiry history corresponding to the delete instruction; however, the translation device 220 in the present embodiment deletes an inquiry history when the number of deletion instructions is larger than or equal to the predetermined number. Deletion of an inquiry history when the number of deletion instructions is larger than or equal to the predetermined number in such a manner may, for example, inhibit deletion of inquiry histories that have to be used by many of the users and do not have to be used only by some of the users.

When, in step S304, the number of delete instructions is not larger than or equal to the predetermined number, this process is completed. On the other hand, when the number of delete instruction is larger than or equal to the predetermined number, the process proceeds to step S306.

In step S306, the inquiry history matching unit 44 deletes an inquiry history corresponding to the deletion instruction from the inquiry history retention unit 46, and then this process is completed.

In such a way, in the translation device 220, an inquiry history that has become unnecessary by the inquiry history deletion process is deleted. This may suppress frequent occurrences of warning. In the translation device 220, since frequent occurrences of warning may be suppressed, conversations are made more smoothly and the time and cost used for warning is reduced.

Note that, in the embodiments described above, the form in which the translation program 92 is stored (installed) in advance in the storage unit 88 has been described, the translation program 92 may be provided in the form of being recorded on a storage medium. Examples of the storage medium include a compact disc read only memory (CD-ROM), a digital versatile disk read only memory (DVD-ROM), and a universal serial bus (USB) memory. The conversation program 72, like the translation program 92, may be provided in the form of being recorded on a storage medium.

In the embodiments described above, the case where the terminal devices 12 of users who converse with each other and the translation devices 20 and 220 are different devices has been described. However, they are not limited to this configuration. For example, in the translation system 10 illustrated in FIG. 1, at least either of the terminal devices 12A and 12B only has to have all the functions of the translation devices 20 and 220. That is, the translation devices 20 and 220 may be included within terminal devices of users who converse with each other.

In the embodiments described above, the case where the translation devices 20 and 220 perform translation in two directions between different languages (Japanese and English) has been described. However, the technique of the present disclosure is applicable to the case where translation in one direction is performed. For example, it is assumed that a translation device that translates a received English message into Japanese for the user A is provided in a terminal device of the user A, and a translation device that translates a received Japanese message into English for the user B is included in a terminal device of the user B. In this case, the terminal devices of both the users A and B have functions of the translation devices 20 and 220, and a substring correspondence table in the substring correspondence table storage unit 38 along with a translation result is transmitted to the conversation partner. Thereby, as in the above, the technique of the present disclosure may be applied to this case.

Additionally, in the embodiments described above, the case where one of the first language and the second language is Japanese and the other is English has been described; however, the kind of language is not limited. For example, instead of English, Chinese may be used, or French or the like may be used.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A translation device comprising:
a saving unit that, when a first original text in a first language is translated into a second translated text in a second language by a first translation unit, saves a first substring included in the first original text and a second substring included in the second translated text and corresponding to the first substring in association with each other;
a second translation unit that translates a second original text in the second language into a first translated text in the first language; and
a control unit that, when an inquiry original text as the second original text is input to the second translation unit, the inquiry original text citing the second substring included in the second translated text output from the first translation unit and inquiring about the second substring, controls the second translation unit so as to substitute the first substring corresponding to the second substring for the second substring included in the inquiry original text based on information saved in the saving unit.

2. The translation device according to claim 1,
wherein the control unit includes
a first detection unit that detects whether or not the second original text is the inquiry original text, and
a second detection unit that, when the first detection unit detects that the second original text is the inquiry original text, with reference to the second translated text, detects whether the second substring is cited.

3. The translation device according to claim 2,
wherein the first detection unit detects whether or not the second original text is the inquiry original text, based on a comparison result obtained by comparing the second original text with a plurality of inquiry sentence patterns predetermined, or an analysis result obtained by carrying out conceptual structure analysis on the second original text.

4. The translation device according to claim 1, further comprising:
a retention unit that, when a second original text is input to the second translation unit, retains the cited second substring and the first substring corresponding to the second substring in association with each other; and
a matching unit that compares the second original text with information retained in the retention unit and that, when at least part of the second original text matches the second substring, transmits, to a source of transmission of the second original text, warning representing presence of a possibility that an inquiry about the second original text will be carried out.

5. The translation device according to claim 2,
wherein the matching unit uses the information retained in the retention unit based on a second original text transmitted by and received by a particular plurality of terminals, for comparison with a second original text transmitted by and received by another plurality of terminals.

6. The translation device according to claim 4,
wherein when, after transmission of the warning, a delete instruction is accepted for the warning, the matching unit deletes, from the retention unit, the information on the second substring corresponding to the warning.

7. The translation device according to claim 6,
wherein the matching unit performs the deleting when a number of times the delete instruction is accepted is larger than or equal to a predetermined number.

8. The translation device according to claim 1,
wherein the control unit includes
a substitution unit that substitutes the first substring corresponding to the second substring based on the information saved in the saving unit, for the second substring included in the inquiry original text, and outputs the inquiry original text with a substituted portion embedded with a control code to the second translation unit, and
wherein the second translation unit translates the inquiry original text except the portion embedded with the control code.

9. A translation method comprising:
when a first original text in a first language is translated into a second translated text in a second language by a first translation unit, saving, by a saving unit, a first substring included in the first original text and a second substring included in the second translated text and corresponding to the first substring in association with each other;
translating, by a second translation unit, a second original text in the second language into a first translated text in the first language; and
when, as the second original text, an inquiry original text citing the second substring included in the second translated text output from the first translation unit and inquiring about the second substring is input to the second translation unit, controlling, by a control unit, the second translation unit so as to substitute the first substring corresponding to the second substring based on information saved in the saving unit, for the second substring included in the inquiry original text.

10. The translation method according to claim 9,
wherein the control unit
by a first detection unit, detects whether or not the second original text is the inquiry original text, and
by a second detection unit, when the first detection unit detects that the second original text is the inquiry original text, with reference to the second translated text, detects whether or not the second substring is cited.

11. The translation method according to claim 10,
wherein the first detection unit detects whether or not the second original text is the inquiry original text, based on a comparison result obtained by comparing the second original text with a plurality of inquiry sentence patterns predetermined, or an analysis result obtained by carrying out conceptual structure analysis on the second original text.

12. The translation method according to claim 9, further comprising:
by a retention unit, when a second original text is input to the second translation unit, retaining the cited second substring and the first substring corresponding to the second substring in association with each other; and
by a matching unit, comparing the second original text with information retained in the retention unit and, when at least part of the second original text matches the second substring, transmitting, to a source of transmission of the second original text, warning representing presence of a possibility that an inquiry about the second original text will be carried out.

13. The translation method according to claim 10,
wherein the matching unit uses the information retained in the retention unit based on a second original text transmitted by and received by a particular plurality of terminals, for comparison with a second original text transmitted by and received by another plurality of terminals.

14. The translation method according to claim 12,
wherein when, after transmission of the warning, a delete instruction is accepted for the warning, the matching unit deletes, from the retention unit, the information on the second substring corresponding to the warning.

15. The translation method according to claim 14,
wherein the matching unit performs the deleting when a number of times the delete instruction is accepted is larger than or equal to a predetermined number.

16. The translation method according to claim 9,
wherein the control unit
by a substitution unit, substitutes the first substring corresponding to the second substring based on the information saved in the saving unit, for the second substring included in the inquiry original text, and outputs the inquiry original text with a substituted portion embedded with a control code to the second translation unit, and
wherein the second translation unit translates the inquiry original text except the portion embedded with the control code.

17. A non-transitory computer-readable recording medium having therein a translation program for causing a computer to execute a process, the process comprising:
when a first original text in a first language is translated into a second translated text in a second language by a first translation unit, saving, in a saving unit, a first substring included in the first original text and a second substring included in the second translated text and corresponding to the first substring in association with each other;
translating a second original text in the second language into a first translated text in the first language; and
when, as the second original text, an inquiry original text citing a second substring included in the second translated text output from the first translation unit and inquiring about the second substring is input, performing control so as to substitute the first substring corresponding to the second substring based on information saved in the saving unit, for the second substring included in the inquiry original text.

18. The non-transitory computer-readable recording medium according to claim 17,
wherein the performing control includes
a first detection process of detecting whether or not the second original text is the inquiry original text, and
a second detection process of, when it is detected that the second original text is the inquiry original text, with reference to the second translated text, detecting whether or not the second substring is cited.

19. The non-transitory computer-readable recording medium according to claim 18,
wherein the first detection process is a process of detecting whether or not the second original text is the inquiry original text, based on a comparison result obtained by comparing the second original text with a plurality of inquiry sentence patterns predetermined, or an analysis result obtained by carrying out conceptual structure analysis on the second original text.

20. The non-transitory computer-readable recording medium according to claim 17, the process further comprising:
when a second original text is input to the second translation unit, retaining, in a retention unit, the cited second substring and the first substring corresponding to the second substring in association with each other; and
comparing the second original text with information retained in the retention unit and, when at least part of the second original text matches the second substring, transmitting, to a source of transmission of the second original text, warning representing presence of a possibility that an inquiry about the second original text will be carried out.
